(19) United States
(12) Patent Application Publication
(10) Pub. No.: US 2019/0196566 A1
(43) Pub. Date: Jun. 27, 2019

(54) LOW POWER INTERNET OF THINGS (IOT) DEVICE WITH SWAPPABLE COMMUNICATION MODULE

(71) Applicant: ESMART TECH, INC., San Diego, CA (US)

(72) Inventors: Kenny Fok, San Diego, CA (US); Jim McLaughlin, San Diego, CA (US); David Diplock, Alpine, CA (US); Abad Vera, Murrieta, CA (US); Eric Sterrett, Poway, CA (US); Niral Bhalodia, San Diego, CA (US)

(21) Appl. No.: 15/853,759

(22) Filed: Dec. 23, 2017

(51) Int. Cl. G06F 1/32; H04W 76/28; H04W 52/02

(52) U.S. Cl. CPC G06F 1/3206; G06F 1/3287; H04W 52/0216; H04W 76/28

(57) ABSTRACT

A low power internet of things (IoT) device includes: a power source; a controller coupled to the power source; a selectively enabled power converter coupled to the power source; and a selectively enabled communication module coupled to the power converter. An automated method of controlling a low power IoT device includes: monitoring a set of hardware triggers; determining whether a set of communication criteria has been met; enabling a communication module of the IoT device if the set of communication criteria has been met; and disabling the communication module after determining that communication has been completed. A low power IoT system includes: a low power IoT device including: a power source; a controller coupled to the power source; a selectively enabled power converter coupled to the power source; and a selectively enabled communication module coupled to the power converter; and a server.

### BACKGROUND

There is large consumer demand for wireless internet of things (IoT) devices that utilize wireless communication pathways. Such devices may typically use rechargeable or single-use batteries. As such, power consumption of IoT devices must be limited in order to extend battery life or time between recharging.

Communication elements (e.g., wireless transmitters and receivers) may consume large amounts of power. Such elements may vary depending on device type, protocol, etc.

Thus there is a need for a way to reduce power consumed by communication elements that is able to be utilized across multiple platforms.

### SUMMARY

Some embodiments provide a low power internet of things (IoT) device. The device may include a power source, power converter, controller, various hardware triggers, and a communication module.

The power converter and communication module may be selectively enabled and/or disabled by the controller based on analysis of the various hardware triggers. When disabled, the power converter and communication module may draw no current in order to reduce power consumption.

The controller may be a low power microcontroller that is able to accept a range of supply voltages, and may thus be connected to the power source without any intervening elements, such as a power converter.

The hardware triggers may include various sensor outputs, logic signals (e.g., timers), and/or other appropriate triggers. Such triggers may include digital and/or analog signals. Such signals may be associated with various states of the IoT device (and/or components thereof).

The controller may enable to the power converter and communication module only when the hardware triggers satisfy some activation criteria. The power converter and communication module may be deactivated once the communication is complete (or the activation criteria is no longer met).

The preceding Summary is intended to serve as a brief introduction to various features of some exemplary embodiments. Other embodiments may be implemented in other specific forms without departing from the scope of the disclosure.

### BRIEF DESCRIPTION OF THE SEVERAL VIEWS OF THE DRAWINGS

The exemplary features of the disclosure are set forth in the appended claims. However, for purpose of explanation, several embodiments are illustrated in the following drawings.

FIG. 1 illustrates a schematic block diagram of a low power internet of things (IoT) device according to an exemplary embodiment;

FIG. 2 illustrates a schematic block diagram of a system that utilizes the low power IoT device of FIG. 1;

FIG. 3 illustrates a flow chart of an exemplary process that activates and deactivates a communication module of the low power IoT device of FIG. 1; and

FIG. 4 illustrates a schematic block diagram of an exemplary computer system used to implement some embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide a low power internet of things (IoT) device.

A first exemplary embodiment provides a low power IoT device comprising: a power source; a controller coupled to the power source; a selectively enabled power converter coupled to the power source; and a selectively enabled communication module coupled to the power converter.

A second exemplary embodiment provides an automated method of controlling a low power IoT device, the method comprising: monitoring a set of hardware triggers; determining whether a set of communication criteria has been met; enabling a communication module of the IoT device if the set of communication criteria has been met; and disabling the communication module after determining that communication has been completed.

A third exemplary embodiment provides a low power internet of things (IoT) system comprising: a low power IoT device including: a power source; a controller coupled to the power source; a selectively enabled power converter coupled to the power source; and a selectively enabled communication module coupled to the power converter; and a server.

Several more detailed embodiments are described in the sections below. Section I provides a description of a hardware architecture of some embodiments. Section II then describes methods of operation used by some embodiments. Lastly, Section III describes a computer system which implements some of the embodiments.

### I. Hardware Architecture

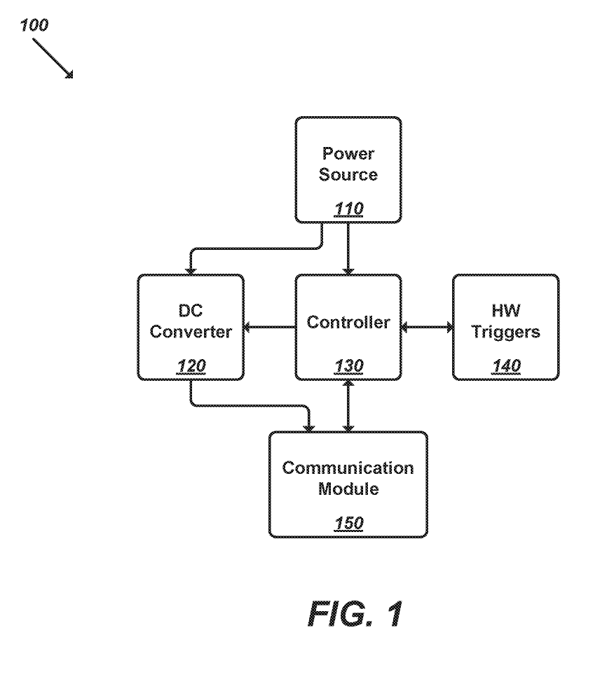

FIG. 1 illustrates a schematic block diagram of a low power internet of things (IoT) device 100 according to an exemplary embodiment. As shown, the device may include a power source 110, DC converter 120, controller 130, hardware triggers 140, and a communication module 150.

The power source 110 may include any suitable components able to provide power to the IoT device 100. For instance, the power source 110 may include one or more batteries (single-use and/or rechargeable), hardwired power connections, and/or other appropriate elements (e.g., solar cells).

The DC converter 120 may be able to generate a power supply appropriate for the communication module 150. The converter 120 may include various electronic components and/or circuitry. The converter may be controllable by a resource such as controller 130. The converter 120 may be able to be activated or deactivated by the controller 130.

The controller 130 may be a microcontroller or other appropriate device. The controller may be able to accept a large range of supply voltage, allowing the microcontroller to be directly connected to the power source without needing any power converter. Such an arrangement reduces consumed power related to the power converter. The controller may be a low-power device (e.g., less than fifty microamperes).

The hardware triggers 140 may include various sensors, wake-up timers, logic circuits, other circuitry, etc. that may be used to determine when the communication module 150 should be activated.

The trigger type may be based on attributes and/or measurements of the IoT device 100. For instance, if the IoT device is a smart thermostat, a trigger may indicate that a measured temperature has exceeded a specified threshold. As another example, if the IoT device is a heart monitoring implant, the trigger may indicate that a measured heart rate has exceeded a specified value. If the IoT device is a security camera, the trigger may indicate that motion has been detected. The trigger may be based on various user preferences or other specified parameters.

In some embodiments, the trigger may be generated by a timer or other feature that is independent of any measured or sensed information. For instance, an air quality measurement device, may send a trigger at regular time intervals indicating that measured values are ready for transmission.

In some cases, a trigger may only be generated upon satisfaction of multiple criteria. For instance, a smart thermostat may only send a trigger if a temperature threshold is exceeded and air conditioning is activated or “turned on” (i.e., if air conditioning is not active, such as outside business hours, no trigger may be generated even though a specified high temperature threshold has been exceeded).

In some embodiments, the trigger may be associated with a specific communication pathway (e.g., Wi-Fi, Bluetooth, etc.). In such cases, multiple communication modules 150 may be available, and the trigger may specify which module(s) should be activated.

The trigger source 140 may be external to the IoT device 100 in some cases. Such external triggers 140 may have wired connections that allow communication even when module 150 is inactive. For instance, a camera may be connected to a motion sensor, where sensed motion generates a trigger signal that is received at the camera.

The communication module 150 may allow the device 100 to communicate across various pathways. Such pathways may include wired connections (e.g., USB, Ethernet, etc.), wireless (e.g., Wi-Fi, Bluetooth, etc.), and/or distributed connections (e.g., cellular networks, the Internet, etc.). Some embodiments may include multiple communication modules 150, each associated with a set of communication pathways. The communication module(s) may be controllable by a resource such as controller 130. The communication module(s) 150 may be able to be activated or deactivated by the controller 130.

The communication module 150 may include a processor (in addition to controller 130). Such a processor may allow the controller 130 to be a low power device, as the controller does not have to oversee communications.

Throughout this disclosure, when the communication module 150 and/or power converter 120 are described as being “deactivated”, “disabled”, “off”, etc., the modules 150 and 120 may be completely disconnected from the power source (and/or otherwise completely disabled) such that the modules do not draw any power in such a state even while the other component of the device 100 are fully operational. Likewise, when the module 150 and/or converter 120 are described as being “activated”, “enabled”, “on”, etc., the modules 150 and 120 may be connected to the power source 110 and/or otherwise made operational. Of course, module 150 will draw power via module 120 when active.

The device 100 design described above may allow the communication module 150 to be hot-swappable (i.e., the controller 130 may only enable or disable the communication module 150 without overseeing the communication itself), such that any communication module may be used with the device 100.

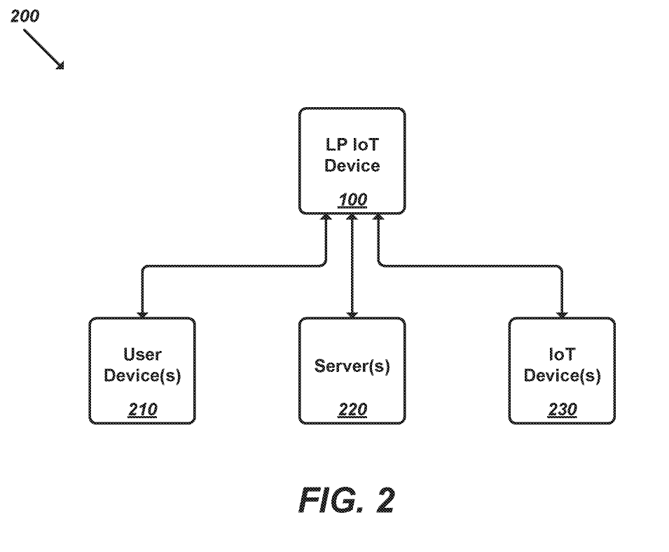

FIG. 2 illustrates a schematic block diagram of a system 200 that utilizes the low power IoT device 100. As shown, the system 200 may include the low-power IoT device 100, a number of user devices 210, a set of servers 220, and a set of IoT devices 230.

Each user device 210 may be a smartphone, tablet, personal computer, and/or other appropriate device that is able to interact with the IoT device 100. In some embodiments, the IoT device may use various communication capabilities of the user device(s) 210 in order to communicate with other system components. For instance, the IoT device 100 may connect to the user device 210 over a local wireless connection (e.g., Bluetooth) and may utilize cellular communication capabilities of the user device 210 to interact with the server(s) 220.

Each server 220 may be an electronic device that is able to execute instructions and/or otherwise process data. The server(s) may be associated with various storages (not shown) that may provide various database functionality for the IoT device 100 and/or other devices of system 200.

Each IoT device 230 may be another low power IoT device or any other type of IoT device. Such devices may provide various communication pathways, resources, etc. Likewise, the low power IoT device 100 may provide communication pathways, resources, etc. to any other IoT devices 230 that are able to communicate with device 100.

One of ordinary skill in the art will recognize that the device 100 and system 200 described above may be implemented in various different ways without departing from the scope of the disclosure. For instance, different embodiments may include additional modules and/or devices than shown (e.g., one or more sensor interface modules). As another example, some embodiments may omit various modules and/or devices. In addition, the various modules and/or devices may be arranged in different ways with different communication pathways. Furthermore, multiple modules may be combined into a single module and/or a single module may be divided into multiple sub-modules.

### II. Methods of Operation

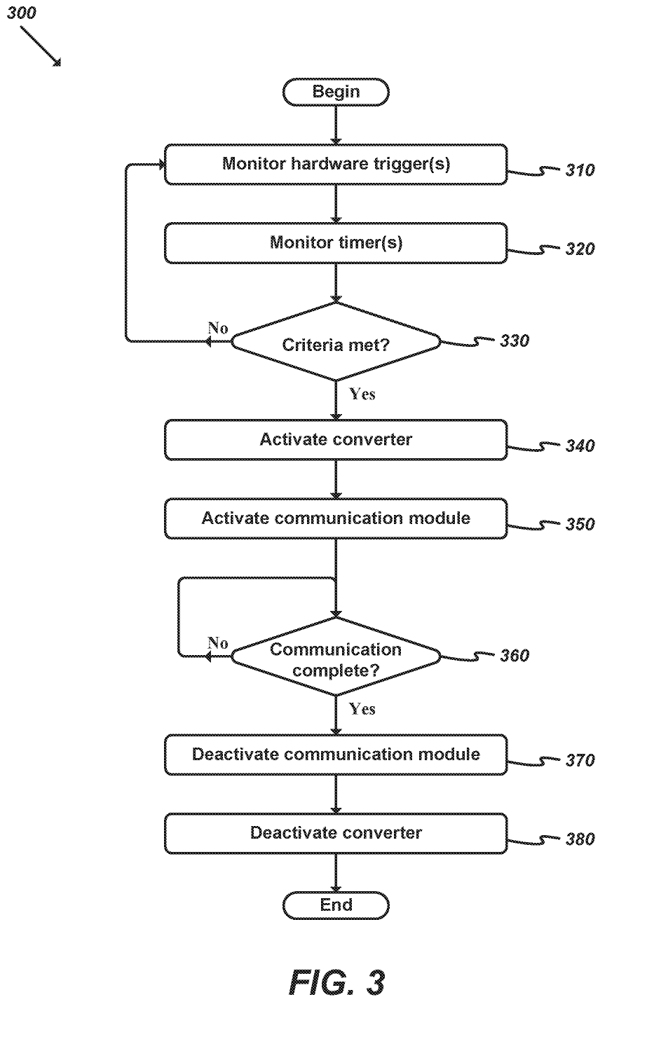

FIG. 3 illustrates a flow chart of an exemplary process 300 that activates and deactivates a communication module 150 of the low power IoT device 100. Such a process may be executed by a device such as IoT device 100, specifically by a module such as controller 130. The process may begin, for instance, when such a device is powered on.

As shown, the process may monitor (at 310) the various available hardware triggers. Next, the process may monitor (at 320) any timers associated with the IoT device. Such triggers and/or timers may be associated with various digital and/or analog signals that may be analyzed in order to identify any trigger events (e.g., threshold exceeded, timer countdown, etc.). Throughout the disclosure, “triggers” may also refer to timers or other signals that may be used to identify events that require activation of a communication module.

Next, the process may determine (at 330) whether any communication criteria has been met. Such determination may be based on analysis of received triggers, timer information, etc. In some cases, the communication criteria may include identification of a request from a sensor or other element of the IoT device 100.

If the process determines (at 330) that no communication criteria has been met, the process may repeat operations 310-330 until the process determines (at 330) that some communication criteria has been met.

If the process determines (at 330) that some communication criteria has been met, the process may activate (at 340) the power converter 120 of some embodiments. Next the process may activate (at 350) the communication module 150 of some embodiments. The communication module may then be utilized by the IoT device 100 to send and/or receive communications over the available pathway(s).

Such communications may include two-way communications. For instance, the IoT device 100 and a user device 210 may communicate over a Bluetooth channel such that a user may set various attributes of the IoT device 100 (e.g., thresholds, status, etc.).

Some communications may include one-way transmissions. For example, the IoT device 100 may send measured data to the server 220 at regular intervals.

The process may then determine (at 360) whether the communications are complete. Such a determination may be made based on various relevant factors, such as messages received from components of the IoT device 100, acknowledgement or other messages received from the user device 210 or server 220, etc.

For instance, a particular IoT device 100 may regularly send a fixed number of messages to transmit data to an external resource. The device may determine when the message sequence is complete and then may determine communications are complete.

In some cases, the determination may be made based on a timer or other usage statistics. For instance, if no message has been sent or received for a specified time, the process may determine (at 360) that communications are complete.

The communication module may allow the IoT device 100 to send messages to a cloud server or application running on a user device (and/or receive messages therefrom).

The process may monitor (at 360) communications until the process determines (at 360) that communications have been completed. Next, the process may deactivate (at 370) the communication module, deactivate (at 380) the power converter, and then may end. As described above, in order to consume a minimum amount of power, when the power converter and communication module are deactivated, they may be completely disconnected from any power source such that no current is drawn. This is in contrast to a “sleep” or low power mode of operation where some current still flows through those modules.

One of ordinary skill in the art will recognize that process 300 may be implemented in various different ways without departing from the scope of the disclosure. For instance, some embodiments may include other operations or omit various listed operations. As another example, different embodiments may perform the operations in different orders. In addition, the process (and/or various sets of operations) may be performed iteratively, or based on satisfaction of some criteria.

### III. Computer System

Many of the processes and modules described above may be implemented as software processes that are specified as one or more sets of instructions recorded on a non-transitory storage medium. When these instructions are executed by one or more computational element(s) (e.g., microprocessors, microcontrollers, digital signal processors (DSPs), application-specific integrated circuits (ASICs), field programmable gate arrays (FPGAs), etc.) the instructions cause the computational element(s) to perform actions specified in the instructions.

In some embodiments, various processes and modules described above may be implemented completely using electronic circuitry that may include various sets of devices or elements (e.g., sensors, logic gates, analog to digital converters, digital to analog converters, comparators, etc.). Such circuitry may be able to perform functions and/or features that may be associated with various software elements described throughout.

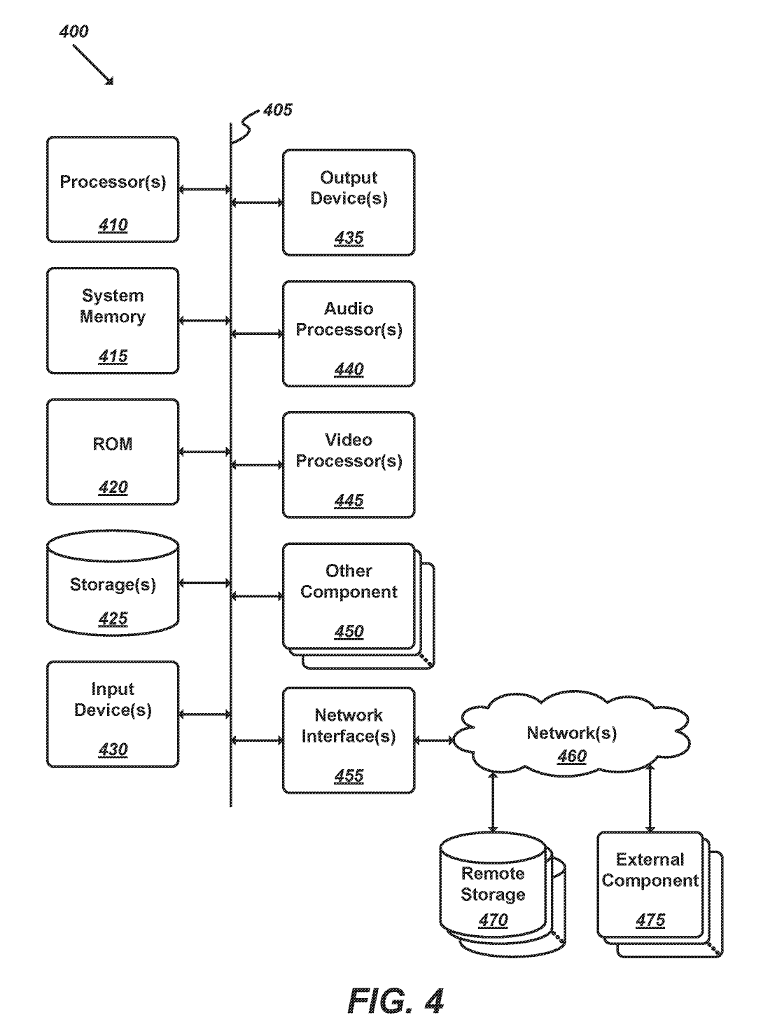

FIG. 4 illustrates a schematic block diagram of an exemplary computer system 400 used to implement some embodiments. For example, the system described above in reference to FIG. 1 may be at least partially implemented using computer system 400. As another example, the process described in reference to FIG. 3 may be at least partially implemented using sets of instructions that are executed using computer system 400.

Computer system 400 may be implemented using various appropriate devices. For instance, the computer system may be implemented using one or more personal computers (PCs), servers, mobile devices (e.g., a smartphone), tablet devices, and/or any other appropriate devices. The various devices may work alone (e.g., the computer system may be implemented as a single PC) or in conjunction (e.g., some components of the computer system may be provided by a mobile device while other components are provided by a tablet device).

As shown, computer system 400 may include at least one communication bus 405, one or more processors 410, a system memory 415, a read-only memory (ROM) 420, permanent storage devices 425, input devices 430, output devices 435, audio processors 440, video processors 445, various other components 450, and one or more network interfaces 455.

Bus 405 represents all communication pathways among the elements of computer system 400. Such pathways may include wired, wireless, optical, and/or other appropriate communication pathways. For example, input devices 430 and/or output devices 435 may be coupled to the system 400 using a wireless connection protocol or system.

The processor 410 may, in order to execute the processes of some embodiments, retrieve instructions to execute and/or data to process from components such as system memory 415, ROM 420, and permanent storage device 425. Such instructions and data may be passed over bus 405.

System memory 415 may be a volatile read-and-write memory, such as a random access memory (RAM). The system memory may store some of the instructions and data that the processor uses at runtime. The sets of instructions and/or data used to implement some embodiments may be stored in the system memory 415, the permanent storage device 425, and/or the read-only memory 420. ROM 420 may store static data and instructions that may be used by processor 410 and/or other elements of the computer system.

Permanent storage device 425 may be a read-and-write memory device. The permanent storage device may be a non-volatile memory unit that stores instructions and data even when computer system 400 is off or unpowered. Computer system 400 may use a removable storage device and/or a remote storage device as the permanent storage device.

Input devices 430 may enable a user to communicate information to the computer system and/or manipulate various operations of the system. The input devices may include keyboards, cursor control devices, audio input devices and/or video input devices. Output devices 435 may include printers, displays, audio devices, etc. Some or all of the input and/or output devices may be wirelessly or optically connected to the computer system 400.

Audio processor 440 may process and/or generate audio data and/or instructions. The audio processor may be able to receive audio data from an input device 430 such as a microphone. The audio processor 440 may be able to provide audio data to output devices 440 such as a set of speakers. The audio data may include digital information and/or analog signals. The audio processor 440 may be able to analyze and/or otherwise evaluate audio data (e.g., by determining qualities such as signal to noise ratio, dynamic range, etc.). In addition, the audio processor may perform various audio processing functions (e.g., equalization, compression, etc.).

The video processor 445 (or graphics processing unit) may process and/or generate video data and/or instructions. The video processor may be able to receive video data from an input device 430 such as a camera. The video processor 445 may be able to provide video data to an output device 440 such as a display. The video data may include digital information and/or analog signals. The video processor 445 may be able to analyze and/or otherwise evaluate video data (e.g., by determining qualities such as resolution, frame rate, etc.). In addition, the video processor may perform various video processing functions (e.g., contrast adjustment or normalization, color adjustment, etc.). Furthermore, the video processor may be able to render graphic elements and/or video.

Other components 450 may perform various other functions including providing storage, interfacing with external systems or components, etc.

Finally, as shown in FIG. 4, computer system 400 may include one or more network interfaces 455 that are able to connect to one or more networks 460. For example, computer system 400 may be coupled to a web server on the Internet such that a web browser executing on computer system 400 may interact with the web server as a user interacts with an interface that operates in the web browser. Computer system 400 may be able to access one or more remote storages 470 and one or more external components 475 through the network interface 455 and network 460. The network interface(s) 455 may include one or more application programming interfaces (APIs) that may allow the computer system 400 to access remote systems and/or storages and also may allow remote systems and/or storages to access computer system 400 (or elements thereof).

As used in this specification and any claims of this application, the terms “computer”, “server”, “processor”, and “memory” all refer to electronic devices. These terms exclude people or groups of people. As used in this specification and any claims of this application, the term “non-transitory storage medium” is entirely restricted to tangible, physical objects that store information in a form that is readable by electronic devices. These terms exclude any wireless or other ephemeral signals.

It should be recognized by one of ordinary skill in the art that any or all of the components of computer system 400 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

The foregoing relates to illustrative details of exemplary embodiments and modifications may be made without departing from the scope of the disclosure as defined by the following claims.

We claim:

1. A low power internet of things (IoT) device comprising:
a power source;
a controller coupled to the power source;
a selectively enabled power converter coupled to the power source; and
a selectively enabled communication module coupled to the power converter.

2. The low power IoT device of claim 1, wherein the controller is a low power microcontroller.

3. The low power IoT device of claim 1, wherein the communication module provides wireless communication.

4. The low power IoT device of claim 1, wherein the power source is a battery.

5. The low power IoT device of claim 1, wherein the power converter and communication module draw no current if disabled.

6. The low power IoT device of claim 1, wherein the power converter and communication module are enabled based on a hardware trigger received at the controller.

7. The low power IoT device of claim 1, wherein the communication module comprises a processor that directs the operation of the communication module.

8. An automated method of controlling a low power internet of things (IoT) device, the method comprising:
monitoring a set of hardware triggers;
determining whether a set of communication criteria has been met;
enabling a communication module of the IoT device if the set of communication criteria has been met; and
disabling the communication module after determining that communication has been completed.

9. The automated method of claim 8 further comprising enabling a power converter if the set of communication criteria has been met, wherein the power converter provides power to the communication module.

10. The automated method of claim 9 further comprising disabling the power converter after determining that communication has been completed.

11. The automated method of claim 8, wherein the monitoring, determining, enabling, and disabling are performed by a low power microcontroller included in the low power IoT device.

12. The automated method of claim 11, wherein the communication module includes a dedicated processor.

13. The automated method of claim 8, wherein the set of hardware triggers comprises at least one wake-up timer.

14. The automated method of claim 8, wherein the communication module provides a communication pathway between the low power IoT device and at least one of a user device, server, and external IoT device.

15. A low power internet of things (IoT) system comprising:
a low power IoT device including:
a power source;
a controller coupled to the power source;
a selectively enabled power converter coupled to the power source; and
a selectively enabled communication module coupled to the power converter; and
a server.

16. The low power IoT system of claim 15 further comprising a user device.

17. The low power IoT system of claim 16, wherein the low power IoT device is able to communicate with at least one of the server and the user device via the communication module.

18. The low power IoT system of claim 15 further comprising at least one other IoT device.

19. The low power IoT system of claim 15, wherein the controller enables to power converter and the communication module when a set of communication criteria is satisfied.

20. The low power IoT system of claim 19, wherein the set of communication criteria includes a set of hardware triggers.
